(19) United States
(12) Patent Application Publication
(10) Pub. No.: US 2012/0113577 A1
(43) Pub. Date: May 10, 2012

(54) Front-Accessible Computer Interface Box

(76) Inventor: Pin Chao, Taipei County (TW)

(21) Appl. No.: 12/940,875

(22) Filed: Nov. 5, 2010

(51) Int. Cl. G06F 1/16

(52) U.S. Cl. 361/679.02

(57) ABSTRACT

A front-accessible computer interface box comprises a box matching with an HDD/ODD installation bay; front USB interfaces arranged in the front side of the box; a power socket arranged in the front side of the box; and a control circuit board arranged inside the box and electrically connected with the front USB interfaces and power socket. The front side of the box also has a dual-power ESATA interface. The front-accessible computer interface box is designed to exactly fit an unused HDD/ODD installation bay, whereby the present invention can be easily installed and conveniently used.

### BACKGROUND OF THE INVENTION

1. Field of the Invention

The present invention relates to a computer interface expansion device, particularly to a front-accessible computer interface box.

2. Description of the Related Art

It is known by all: A computer has various interfaces to communicate with external devices, such as USB (Universal Serial Bus) interfaces. With rapid development of science and technology, the devices able to communicate with a computer are growing more and more. The few interfaces of a computer have been unable to satisfy requirement. Thus, some manufacturers develop interface expansion devices, such as external expansion cards inserted in the expansion slots and expansion boxes connected to a computer via an external data cable. The expansion slots are usually arranged in near the backside of a computer. In such a case, the expansion interfaces of an external expansion card can only be arranged in the backside of a computer, which is inconvenient for users. An expansion box needs extra space to accommodate it and an extra data cable to connect with a computer, which is also inconvenient for users.

### SUMMARY OF THE INVENTION

One objective of the present invention is to provide a convenient front-accessible computer interface box to overcome the problems of the conventional technologies.

To achieve the abovementioned objective, the present invention adopts the following technical schemes:

The front-accessible computer interface box comprises a box matching with an HDD/ODD installation bay; front USB interfaces arranged in the front side of the box; a power socket arranged in the front side of the box; and a control circuit board arranged inside the box and electrically connected with the front USB interfaces and power socket, Where in the front USB interfaces are USB3.0 interfaces, and where in. The box has at least two front USB interfaces, and where in the front side of the box has a dual-power ESATA (External Serial Advanced Technology Attachment) interface, and where in the front side of the box has a DC (Direct Current) socket to connect with an external power source, and the DC socket is electrically connected with the control circuit board, and where in two lateral sides of the box have screw holes for installation, and where in the box is formed via press-fitting an upper casing and a lower casing.

### BRIEF DESCRIPTION OF THE DRAWINGS

FIG. 1 is a perspective view schematically showing the structure of a front-accessible computer interface box according to one embodiment of the present invention;

FIG. 2 is a perspective view schematically showing the structure of a front-accessible computer interface box from another viewing angle according to one embodiment of the present invention;

FIG. 3 is an exploded view schematically showing the structure of a front-accessible computer interface box according to one embodiment of the present invention;

FIG. 4 is a perspective view schematically showing the front panel of a front-accessible computer interface box according to one embodiment of the present invention; and

FIG. 5 is a perspective view schematically showing the front panel of a front-accessible computer interface box from another viewing angle according to one embodiment of the present invention.

### DETAILED DESCRIPTION OF THE INVENTION

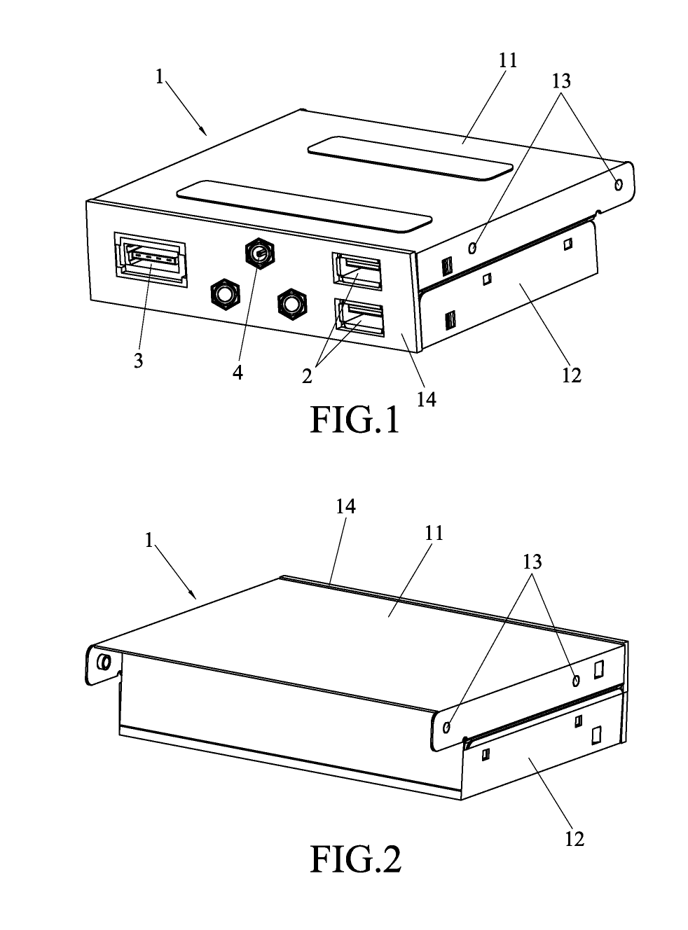

Below, the present invention is further described in detail in cooperation with the attached drawings. Refer to FIGS. 1-3. The front-accessible computer interface box of the present invention comprises a box 1, such as a box compatible with a 3.5 or 5 inch HDD/ODD installation bay. The dimensions of the box can be modified to meet practical requirement. The front side of the box 1 has front USB interfaces 2, a power socket 4 and a control circuit board (not shown in the drawings) electrically connected with the front USB interfaces 2 and power socket 4. In other words, the front USB interfaces 2 directly communicate with other components via the control circuit board.

In one embodiment, the front USB interfaces 2 are USB3.0 interfaces that have higher data transmission speed. The box 1 may have two front USB interfaces 2 but is not limited to only have two front USB interfaces 2

In one embodiment, the front side of the box 1 has a dual-power ESATA (External Serial Advanced Technology Attachment) interface 3, which can transmit data faster. As the dual-power ESATA interface 3 not only can transmit data but also can receive/output power. Thus is enriched the expansion interface of the present invention.

In one embodiment, the front side of the box 1 has a DC socket 4 electrically connected with the control circuit board and used to receive external power. When the system has higher load and the internal power source of the computer cannot supply sufficient power, the DC socket 4 can connect with an external DC power source, such as a 12V power source, to supply sufficient power for the system.

In one embodiment, two lateral sides of the box 1 have installation screw holes 13, whereby the box 1 can be securely installed in the HDD/ODD installation bay of a computer chassis. Besides, the box 1 is formed via press-fitting an upper casing and a lower casing.

A computer chassis normally have several HDD/ODD installation bays, and some of them are unused. The front-accessible computer interface box of the present invention can be directly installed in the unused HDD/ODD installation bay. Therefore, the present invention realizes the front expansion of two USB3.0 interfaces and a dual-power ESATA interface, whereby external devices can communicate with the computer conveniently.

Therefore, the front-accessible computer interface box of the present invention realizes front expansion of interfaces without via PCB installed in the box but via directly connecting the interfaces with the internal expansion card inserted in the expansion slot in the motherboard of a computer. The box 1 of the present invention is designed to exactly fit an unused HDD/ODD installation bay, whereby the present invention can be easily installed, and whereby the space of a computer chassis is fully utilized.

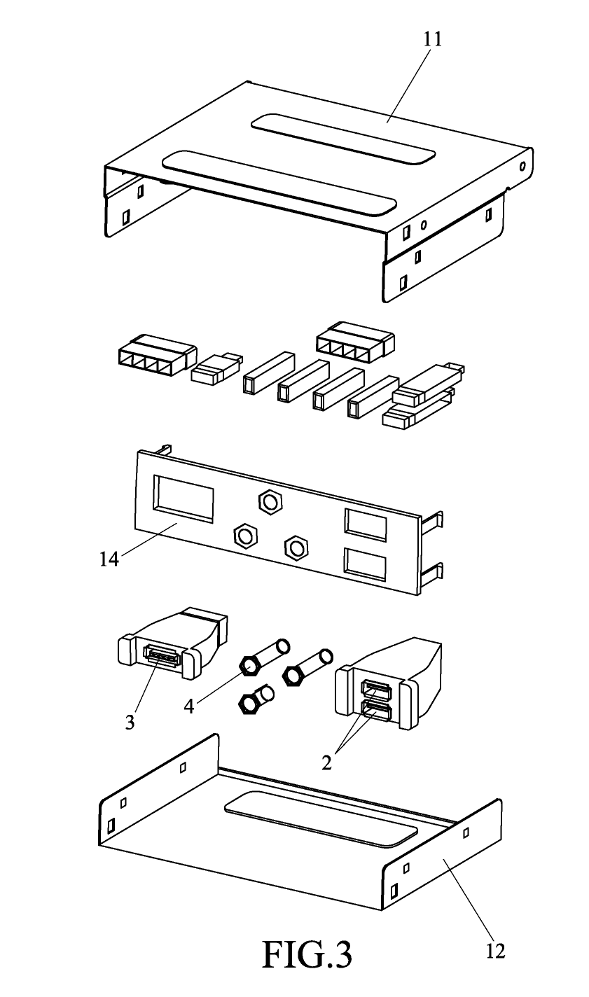

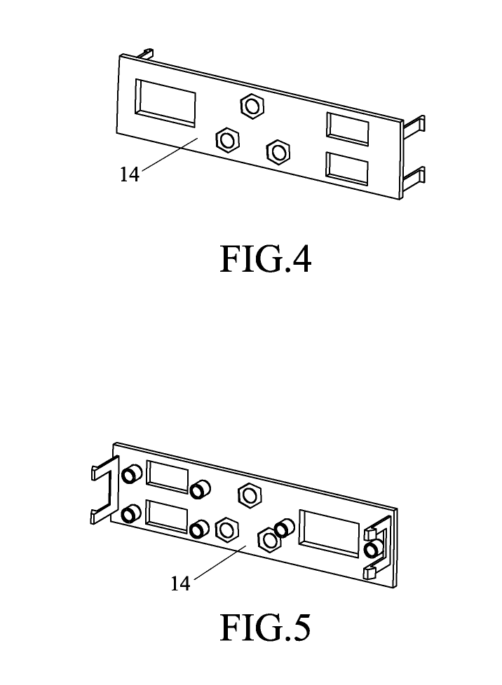

Refer to FIG. 3 and FIG. 4. The front panel 14 of the present invention is fixed from the interior of the computer via an internal screw locking design. Therefore, the appearance of the front panel 14 of the front-accessible computer interface box is very smooth and artistic.

The embodiments described above are only to exemplify the present invention but not to limit the scope of the present invention. Any equivalent modification or variation according to the structures, characteristics and principles disclosed in the specification is to be also included within the scope of the present invention, which is based on the claims stated below.

What is claimed is:

1. A front-accessible computer interface box comprising a box matching with a hard disc drive or optical disc drive installation bay;
front USB (Universal Serial Bus) interfaces arranged in a front side of said box;
a power socket arranged in said front side of said box; and
a control circuit board arranged inside said box and electrically connected with said front USB interfaces and said power socket.

2. The front-accessible computer interface box according to claim 1, wherein said front USB interfaces are USB3.0 interfaces.

3. The front-accessible computer interface box according to claim 1, wherein said box has a plurality of said front USB interfaces.

4. The front-accessible computer interface box according to claim 1, wherein said front side of said box has a dual-power ESATA (External Serial Advanced Technology Attachment) interface.

5. The front-accessible computer interface box according to claim 1, wherein said front side of said box has a DC socket used to receive external power and electrically connected with said control circuit board.

6. The front-accessible computer interface box according to claim 1, wherein two lateral sides of said box have installation screw holes.

7. The front-accessible computer interface box according to claim 1, wherein said box is formed via press-fitting an upper casing and a lower casing.
